(19) United States
(12) Patent Application Publication
(10) Pub. No.: US 2006/0262131 A1
(43) Pub. Date: Nov. 23, 2006

(54) ELECTRONIC APPLIANCE CAPABLE OF ADJUSTING LUMINANCE ACCORDING TO BRIGHTNESS OF ITS ENVIRONMENT

(76) Inventors: Ming-Hong Ni, Taipei Hsien (TW); Chao-Chin Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/380,655

(22) Filed: Apr. 28, 2006

(30) Foreign Application Priority Data
Apr. 29, 2005 (TW) 094113896

(51) Int. Cl. G09G 5/02

(52) U.S. Cl. 345/591

(57) ABSTRACT

An electronic appliance includes a housing, a light module installed inside the housing, an optical sensor installed inside the housing for sensing external light so as to generate a first color signal of a first color space, an image processor for converting the first color signal transmitted from the optical sensor into a second color signal of a second color space, and a controller for adjusting an input voltage of the light module according to the second color signal so as to adjust luminance of the light module.

### BACKGROUND OF THE INVENTION

1. Field of the Invention

The present invention relates to an electronic appliance capable of adjusting luminance according to the brightness of its environment, and more particularly, to an electronic appliance capable of adjusting luminance of light-emitting components of the electronic appliance according to a Y component of a color signal generated from received external light.

2. Description of the Prior Art

In highly developed information communication systems in the modern information society, electronic devices are widely utilized in every area. For instance, the utilization of a convenient and lightweight mobile phone device has become a common way of communication in our daily lives. Users can easily exchange and share information, experiences, and opinions through the convenience of mobile phones. Mobile phones have progressed tremendously in recent years and various types of mobile phones are continuously being developed. As mobile phones are becoming more common the related technology matures with the trend moving towards smaller multi-functional phones. The important issue now is how to reduce power consumption of mobile phones.

As for light-emitting components of electronic appliances, light-emitting diodes are installed below a keyboard of the electronic appliance for lighting the keyboard at night or in the dark. Generally, there are six to eight light-emitting diodes positioned below the keyboard. When an event such as keys of a keyboard being pressed, an incoming call, an alarm warning, or an incoming message is triggered, the light-emitting diodes positioned below the keyboard illuminate for lighting the keyboard. When the electronic appliance is idle, the light-emitting diodes are turned off so as to reduce power consumption. In addition, a backlight module of the electronic appliance can provide high-brightness and uniform light for a display panel. However, the light-emitting components consume much electricity of the electronic appliance. There is a need to reduce power consumption of light-emitting components of electronic appliances so as to extend idle time.

### SUMMARY OF THE INVENTION

It is therefore a primary objective of the claimed invention to provide an electronic appliance capable of adjusting luminance according to brightness of its environment for solving the above-mentioned problem.

According to the claimed invention, an electronic appliance includes a housing, a light module installed inside the housing, an optical sensor installed inside the housing for sensing external light so as to generate a first color signal of a first color space, an image processor for converting the first color signal transmitted from the optical sensor into a second color signal of a second color space, and a controller for adjusting an input voltage of the light module according to the second color signal so as to adjust luminance of the light module.

According to the claimed invention, a method for adjusting luminance of an electronic appliance according to brightness of an environment of the electronic appliance includes: (a) sensing external light; (b) generating a first color signal of a first color space according to the sensing result of step (a); (c) converting the first color signal into a second color signal of a second color space; and (d) adjusting the luminance of the electronic appliance according to the second color signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic appliance according to the present invention.

FIG. 2 is a functional block diagram of the electronic appliance according to the present invention.

FIG. 3 is a flowchart illustrating the electronic appliance adjusting luminance of a light module according to a second color signal according to the present invention.

### DETAILED DESCRIPTION

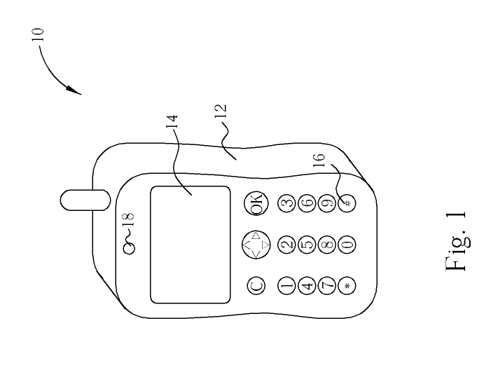

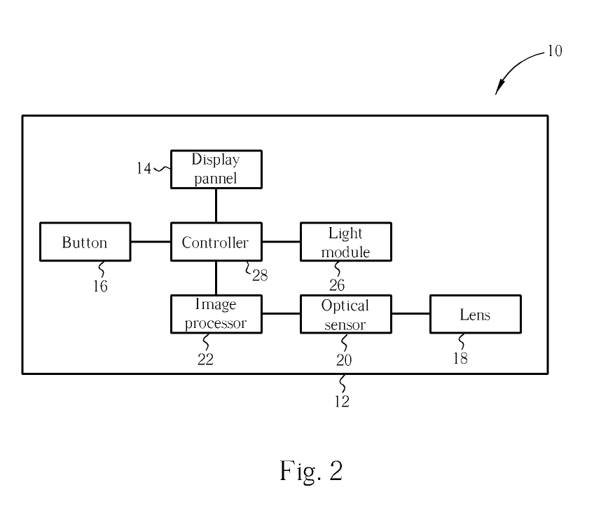

Please refer to FIG. 1 and FIG. 2. FIG. 1 is a schematic diagram of an electronic appliance 10 according to the present invention. FIG. 2 is a functional block diagram of the electronic appliance 10 according to the present invention. The electronic appliance 10 can be a mobile phone with a camera module or a personal digital assistant (PDA). The electronic appliance 10 includes a housing 12 for covering internal components of the electronic appliance 10, a display panel 14 installed inside the housing 12 for displaying images, a plurality of buttons 16 installed on the housing 12 for inputting operation commands, a lens 18 installed on the housing 12 for receiving external light, and an optical sensor 20 installed inside the housing 12 for converting light received by the lens 18 into electrical signals so as to generate a first color signal of a first color space. The more pixels of the optical sensor 20, the higher the resolution of captured images. The optical sensor 20 can include a charge coupled device (CCD) or a complementary metal-oxide semiconductor (CMOS). The electronic appliance 10 further includes an image processor 22 electrically connected to the optical sensor 20 for converting the first color signal transmitted from the optical sensor 20 into a second color signal of a second color space, and a light module 26. The light module 26 can be a backlight module of the display panel 14 or keyboard LEDs installed below the buttons 16. The electronic appliance 10 further includes a controller 28 for adjusting an input voltage of the light module 26 according to the second color signal so as to adjust luminance of the light module 26.

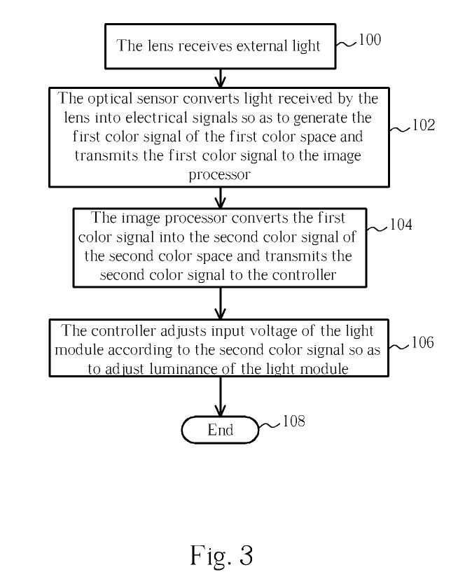

Please refer to FIG. 3. FIG. 3 is a flowchart illustrating the electronic appliance 10 adjusting luminance of the light module 26 according to the second color signal according to the present invention. The method includes the following steps:

Step 100: The lens 18 receives external light.

Step 102: The optical sensor 20 converts light received by the lens 18 into electrical signals so as to generate the first color signal of the first color space and transmits the first color signal to the image processor 22.

Step 104: The image processor 22 converts the first color signal transmitted from the optical sensor 20 into the second color signal of the second color space and transmits the second color signal to the controller 28.

Step 106: The controller 28 adjusts input voltage of the light module 26 according to the second color signal so as to adjust luminance of the light module 26.

Step 108: End.

The detail description of the above-mentioned steps is as follows. The lens 18 of the electronic appliance 10 is a component capable of receiving external light for capturing images, so there is no need to install other components for receiving external light of the electronic appliance 10. The optical sensor 20 converts light received by the lens 18 into electrical signals so as to generate the first color signal at the first color space. The first color space can be an RGB color space, and the first color signal can be an RGB signal. Then, the optical sensor 20 transmits the first color signal to the image processor 22, and the image processor 22 converts the first color signal transmitted from the optical sensor 20 into the second color signal of the second color space. The second color space can be a YUV color space, and the second color signal can be a YUV signal. The conversion relationship between the YUV signal and the RGB signal is:
Y=0.299R+0.587G+0.114B,
U=−0.148R−0.289G+0.437B, and
V=0.615R−0.515G−0.1B.

In addition, the second color space can be a YIQ color space, and the second color signal can be a YIQ signal. The conversion relationship between the YIQ signal and the RGB signal is:
Y=0.299R+0.587G+0.114B,
I=0.596R−0.275G −0.321B, and
Q=0.212R−0.523G+0.311B.

In addition, the second color space can be a YCbCr color space, and the second color signal can be a YCbCr signal. The conversion relationship between the YCbCr signal and the RGB signal is:
Y=0.299R+0.587G+0.114B,
Cb=−0.169R−0.331G+0.5B+128, and
Cr=0.5R−0.4183G−0.0816B+128.

Then, the image processor 22 transmits the second color signal to the controller 28. The Y component of the second color signal is related to brightness of its environment. The controller 28 can adjust an input voltage of the light module 26 according to the Y component of the second color signal so as to adjust luminance of the light module 26. When the brightness of external light is great, like during a sunny day outdoors, a user can see the buttons or message displayed on the display panel 14 clearly. There is no need to provide much light for illuminating the electronic appliance 10, so the input voltage of the light module 26 becomes low by the controller 28 so as to reduce luminance and power consumption of the light module 26. However when the brightness of external light is low, such as at night or in the dark, the user cannot see the buttons or message displayed on the display panel 14 clearly. There is a need to provide much light for illuminating the electronic appliance 10, so the input voltage of the light module 26 becomes high by the controller 28 so as to increase luminance of the light module 26. The trigger to start the procedure of the flowchart of FIG. 3 can be designed according to demand, such as switching from a sleep mode to a regular mode of the electronic appliance 10 or a start/end of a predetermined time interval. In addition, the present invention can be applied to all electronic appliances having illuminated displays, such as a desktop or a notebook computer with a web cam attached on a display monitor.

In contrast to the conventional electronic appliance, the electronic appliance according to the present invention utilizes an existing component capable of receiving external light, such as a lens of a camera module of the electronic appliance, for receiving the surrounding light. The electronic appliance is capable of adjusting luminance of light-emitting components according to surrounding light for reducing power consumption of the electronic appliance so as to extend idle time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic appliance comprising:
a housing;
a light module installed inside the housing;
an optical sensor installed inside the housing for sensing external light so as to generate a first color signal of a first color space;
an image processor for converting the first color signal transmitted from the optical sensor into a second color signal of a second color space; and
a controller for adjusting input voltage of the light module according to the second color signal so as to adjust luminance of the light module.

2. The electronic appliance of claim 1 wherein the light module is a backlight module of a display panel.

3. The electronic appliance of claim 1 wherein the light module is a keyboard LED.

4. The electronic appliance of claim 1 wherein the optical sensor comprises a charge coupled device (CCD).

5. The electronic appliance of claim 1 wherein the optical sensor comprises a complementary metal-oxide semiconductor (CMOS).

6. The electronic appliance of claim 1 wherein the first color space is an RGB color space, the first color signal is an RGB signal, the second color space is a YUV color space, the second color signal is a YUV signal, and the controller adjusts luminance of the light module according to a Y component of the YUV signal.

7. The electronic appliance of claim 1 wherein the first color space is an RGB color space, the first color signal is an RGB signal, the second color space is a YIQ color space, the second color signal is a YIQ signal, and the controller adjusts luminance of the light module according to a Y component of the YIQ signal.

8. The electronic appliance of claim 1 wherein the first color space is an RGB color space, the first color signal is an RGB signal, the second color space is a YCbCr color space, the second color signal is a YCbCr signal, and the controller adjusts luminance of the light module according to a Y component of the YCbCr signal.

9. The electronic appliance of claim 1 wherein the controller adjusts input voltage of the light module according to a Y component of the second color signal.

10. The electronic appliance of claim 1 being a mobile phone.

11. The electronic appliance of claim 1 being a personal digital assistant (PDA).

12. A method for adjusting luminance of an electronic appliance according to brightness of an environment of the electronic appliance, the method comprising:
(a) sensing external light;
(b) generating a first color signal of a first color space according to the sensing result of the external light in step (a);
(c) converting the first color signal into a second color signal of a second color space;
and
(d) adjusting the luminance of the electronic appliance according to the second color signal.

13. The method of claim 12 wherein the first color space is an RGB color space, the first color signal is an RGB signal, the second color space is a YUV color space, the second color signal is a YUV signal, and step (d) comprises adjusting an input voltage of a light module of the electronic appliance according to a Y component of the YUV signal so as to adjust the luminance of the electronic appliance.

14. The method of claim 13 wherein step (c) utilizes a conversion relationship between the YUV signal and the RGB signal, the conversion relationship being Y=0.299R+0.587G+0.114B, U=−0.148R−0.289G+0.437B, and V=0.615R−0.515G−0.1B.

15. The method of claim 12 wherein the first color space is an RGB color space, the first color signal is an RGB signal, the second color space is a YIQ color space, the second color signal is a YIQ signal, and step (d) comprises adjusting an input voltage of a light module of the electronic appliance according to a Y component of the YIQ signal so as to adjust the luminance of the electronic appliance.

16. The method of claim 15 wherein step (c) utilizes a conversion relationship between the YIQ signal and the RGB signal, the conversion relationship being Y=0.299R+0.587G+0.114B, I=0.596R−0.275G−0.321B, and Q=0.212R−0.523G+0.311B.

17. The method of claim 12 wherein the first color space is an RGB color space, the first color signal is an RGB signal, the second color space is a YCbCr color space, the second color signal is a YCbCr signal, and step (d) comprises adjusting an input voltage of a light module of the electronic appliance according to a Y component of the YCbCr signal so as to adjust the luminance of the electronic appliance.

18. The method of claim 17 wherein step (c) utilizes a conversion relationship between the YCbCr signal and the RGB signal, the conversion relationship being Y=0.299R+0.587G+0.114B, Cb=−0.169R−0.331G+0.5B+128, and Cr=0.5R−0.4183G−0.0816B+128.
